(19) United States
(12) Patent Application Publication
(10) Pub. No.: US 2023/0030740 A1
(43) Pub. Date: Feb. 2, 2023

(54) IMAGE ANNOTATING METHOD, CLASSIFICATION METHOD AND MACHINE LEARNING MODEL TRAINING METHOD

(71) Applicant: LEMON INC., Grand Cayman (KY)

(72) Inventors: Jingna SUN, Beijing (CN); Peibin CHEN, Beijing (CN); Weihong ZENG, Beijing (CN); Xu WANG, Beijing (CN); Shen SANG, Los Angeles, CA (US); Jing LIU, Los Angeles, CA (US); Chunpong LAI, Los Angeles, CA (US)

(21) Appl. No.: 17/532,480

(22) Filed: Nov. 22, 2021

(30) Foreign Application Priority Data
Jul. 29, 2021 (CN) 202110862466.2

(51) Int. Cl. G06K 9/62

(52) U.S. Cl. CPC G06K 9/6256; G06K 9/627; G06K 9/6215; G06K 9/6262; G06K 9/00268

(57) ABSTRACT

The present disclosure relates to an image annotating method, classification method and machine learning model training method, and to the field of computer technologies. The image annotating method includes: generating an image tag vector of image to be annotated, according to a plurality of attributes for image annotating and multiple tags corresponding to each of the attributes; annotating an image category to which the image to be annotated belongs, according to vector similarity between the image tag vector and an category tag vector of each of a plurality of image categories, the category tag vector being generated according to the multiple tags corresponding to each of the attributes.

### CROSS-REFERENCE TO RELATED APPLICATIONS

The present disclosure is based on and claims priority of Chinese application for invention No. 202110862466.2, filed on Jul. 29, 2021, the disclosure of which is hereby incorporated into this disclosure by reference in its entirety.

### TECHNICAL FIELD

The present disclosure relates to the field of computer technologies, and particularly, to an image annotating method, image classification method, machine learning model training method, image annotating apparatus, image classification apparatus, machine learning model training apparatus, electronic device and non-transitory computer-readable storage medium.

### BACKGROUND

Training a neural network relies on a large number of annotated data, and the quality of the annotated data will have a great influence on effects of the neural network. In the related art, there are a plurality of ways to improve annotating accuracy for a classification task with less and clearer categories. For example, multi-person annotating voting mechanism and multi-round annotating voting mechanism can be adopted.

### SUMMARY

The SUMMARY portion is provided to introduce, in a brief form, concepts which will be described in detail in the following DETAILED DESCRIPTION portion. The SUMMARY portion is not intended to identify key features or essential features of claimed technical solutions, and is not intended to limit the scope of the claimed technical solutions.

According to some embodiments of the present disclosure, there is provided an image annotating method, comprising: generating an image tag vector of image to be annotated, according to a plurality of attributes for image annotating and multiple tags corresponding to each of the attributes; annotating an image category to which the image to be annotated belongs, according to vector similarity between the image tag vector and a category tag vector of each of a plurality of image categories, wherein the category tag vector is generated according to the multiple tags corresponding to each of the attributes.

According to other embodiments of the present disclosure, there is provided a machine learning model training method, comprising: annotating images in a training image set, by the image annotating method according to any one of the embodiments; training a machine learning model for image classification using the training image set annotated.

According to still other embodiments of the present disclosure, there is provided an image classification method, comprising: processing an image to be classified using a machine learning model to determine an image category to which the image to be classified belongs, the machine learning model being trained using the machine learning model training method according to any one of the embodiments.

According to further embodiments of the present disclosure, there is provided an image annotating apparatus, comprising: a generation unit for generating an image tag vector of image to be annotated, according to a plurality of attributes for image annotating and multiple tags corresponding to each of the attributes; an annotating unit for annotating an image category to which the image to be annotated belongs, according to vector similarity between the image tag vector and a category tag vector of each of a plurality of image categories, the category tag vector being generated according to the multiple tags corresponding to each of the attributes.

According to further embodiments of the present disclosure, there is provided a machine learning model training apparatus, comprising: an annotating unit for annotating images in a training image set, by the image annotating method according to any one of the embodiments; a training unit for training a machine learning model for image classification using the training image set annotated.

According to further embodiments of the present disclosure, there is provided an image classification apparatus, comprising: a processor configured to process an image to be classified using a machine learning model to determine an image category to which the image to be classified belongs, the machine learning model being trained using the machine learning model training method according to any one of the embodiments.

According to further embodiments of the present disclosure, there is provided an electronic device, comprising: a memory; and a processor coupled to the memory, the processor being configured to, based on instructions stored in the memory, implement the image annotating method, the machine learning model training method or the image classification method according to any one of the embodiments in the present disclosure.

According to some embodiments of the present disclosure, there is provided a non-transitory computer-readable storage medium on which a computer program is stored, which when executed by a processor, implements the image annotating method, the machine learning model training method or the image classification method according to any one of the embodiments in the present disclosure.

Other features, aspects, and advantages of the present disclosure will become apparent from the following detailed description of the exemplary embodiments of the present disclosure with reference to the accompanying drawings.

### BRIEF DESCRIPTION OF THE DRAWINGS

Preferred embodiments of the present disclosure will be described below with reference to the accompanying drawings. The accompanying drawings described herein are used for providing further understanding of the present disclosure, and the accompanying drawings, together with the following detailed description, are contained in the specification and form a part of the specification for explanation of the present disclosure. It should be understood that the accompanying drawings in the following description relate only to some embodiments of the present disclosure, and are not intended to limit the present disclosure. In the drawings:

FIG. 1 shows a flowchart of an image annotating method according to some embodiments of the present disclosure;

FIG. 2 shows a flowchart of an image annotating method according to other embodiments of the present disclosure;

FIG. 3 shows a flowchart of a machine learning model training method according to some embodiments of the present disclosure;

FIG. 4 shows a block diagram of an image annotating apparatus according to some embodiments of the present disclosure;

FIG. 5 shows a block diagram of a machine learning model training apparatus according to some embodiments of the present disclosure;

FIG. 6 shows a block diagram of an image classification apparatus according to some embodiments of the present disclosure;

FIG. 7 shows a block diagram of an electronic device according to some embodiments of the present disclosure; and

FIG. 8 shows a block diagram of an electronic device according to other embodiments of the present disclosure.

It should be understood that for ease of description, dimensions of various portions shown in the drawings are not necessarily drawn according to actual scales. Identical or similar reference numerals are used in the drawings to represent identical or similar components. Thus, once a certain item is defined in one drawing, it may not be further discussed in the following drawings.

### DETAILED DESCRIPTION

The technical solutions in the embodiments of the present disclosure will be clearly and completely described below in conjunction with the accompanying drawings in the present disclosure, but it is apparent that the embodiments described are only some of the embodiments of the present disclosure, instead of all of them. The following description of the embodiments is actually only illustrative, and in no way serves as any limitation on the present disclosure and its application or use. It should be understood that the present disclosure can be implemented in a plurality of forms, and should not be construed as limited to the embodiments set forth herein.

It should be understood that steps described in a method embodiment of the present disclosure can be performed in a different order, and/or in parallel. In addition, the method embodiment can comprise an additional step and/or omit performing the steps shown. The scope of this disclosure is not limited in this regard. Unless otherwise specified, relative arrangements of components and steps, numerical expressions and numerical values, which are set forth in these embodiments, should be construed as merely exemplary and do not limit the scope of the present disclosure.

A term “comprise” and its variations, which are used in the present disclosure, refer to an open-minded term comprising at least its following element/feature, but not excluding another element/feature, i.e. “comprising but not limited to”. In addition, a term “comprising” and its variations, which are used in the present disclosure, refer to an open-minded term comprising at least its following element/feature, but not excluding another element/feature, i.e. “comprising but not limited to”. Therefore, comprising is synonymous with comprising. A term “based on” refers to “at least partially based on”.

“One embodiment”, “some embodiments” or “an embodiment” termed throughout the specification means that specific features, structures, or characteristics described in conjunction with an embodiment are comprised in at least one embodiment of the present invention. For example, the term “one embodiment” indicates “at least one embodiment”; the term “another embodiment” indicates “at least one additional embodiment”; the term “some embodiments” indicates “at least some embodiments”. Moreover, a phrase “in one embodiment”, “in some embodiments” or “in an embodiment” appearing in various places throughout the specification does not necessarily refer to a same embodiment, but can also refer to the same embodiment.

It should be noted that concepts of “first”, “second” and the like mentioned in the present disclosure are only used for distinguishing different apparatuses, modules, or units, but not for limiting the order or interdependence of functions performed by these apparatuses, modules, or units. Unless otherwise specified, the concepts of “first”, “second” and the like are not intended to imply that objects so described must be in given order in time, space, ranking or in any other way.

It should be noted that a modification of “one”, “multiple” mentioned in the present disclosure is illustrative rather than restrictive, and it should be appreciated by those skilled in the art that, unless otherwise clearly indicated in the context, it should be understood as “one” or “multiple”.

Names of messages or information interacted between a plurality of apparatuses in the embodiments of the present disclosure are only for illustrative purposes, and are not used for limiting the range of these messages or information.

The embodiments of the present disclosure will be described in detail below in conjunction with the accompanying drawings, but the present disclosure is not limited to these specific embodiments. These following specific embodiments can be combined with each other, and the same or similar concepts or processes may not be repeated in certain embodiments. Moreover, in one or more embodiments, specific features, structures, or characteristics can be combined in any suitable manner that will be clear to those of ordinary skill in the art from the present disclosure.

It should be understood that the present disclosure does not limit how to obtain an image to be applied/processed. In one embodiment of the present disclosure, it can be acquired from a storage device, such as an internal memory, or an external storage device, and in another embodiment of the present disclosure, it can be shot by mobilizing a photographing component. It should be noted that the acquired image can be one collected image, or one frame of images in a collected video, which is not particularly limited thereto.

In the context of the present disclosure, the image can refer to any of a plurality of images, such as a color image, a gray image, and the like. It should be noted that in the context of the present specification, a type of the image is not specifically limited. In addition, the image can be any suitable image, e.g., an original image obtained by a camera, or an image that is the original image having been subject to specific processing, such as preliminary filtering, de-aliasing, color adjustment, contrast adjustment, standardization, and the like. It should be noted that the pretreatment operations can also comprise other types of pretreatment operations known in the art, which will not be described in detail herein.

As mentioned above, for a classification task with more categories and continuous changes or ambiguous states between the categories, an annotating person cannot remember the huge categories and perform accurate annotating. For example, for annotating 45 categories of hairstyles, since there may be only differences in hair length or in curling degree between the categories, it is difficult to annotate the hairstyle task.

Therefore, an annotating task containing small differences and huge categories is a very difficult task.

For the above technical problem, in order to quickly process an annotating task with huge categories and ambiguous states between the categories, the technical solutions of the present disclosure uses basic attributes of relevant categories to calculate similarity between an image and each target category according to the basic attributes; each image can be matched with its most similar category; and finally, it is judged whether it belongs to a target category according to similarity between an annotating sample and a current category.

According to the technical solutions of the present disclosure, the annotating task with huge categories and ambiguity between categories, which is similar to the problem of classifying 45 categories of hairstyles, can be quickly handled, which improves the annotating quality and annotating efficiency. For example, the technical solutions of the present disclosure can be implemented by the following embodiments.

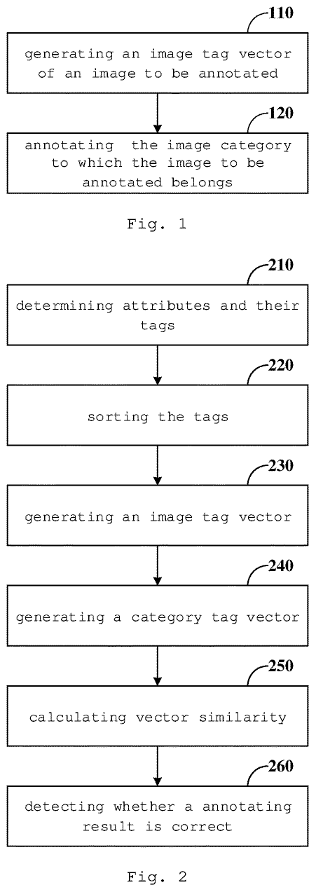

FIG. 1 shows a flowchart of an annotating method according to some embodiments of the present disclosure.

As shown in FIG. 1, in step 110, an image tag vector of image to be annotated is generated according to a plurality of attributes for image annotating and multiple tags corresponding to each of the attributes.

In some embodiments, the plurality of attributes for image annotating are independent of each other. The multiple tags corresponding to each of the attributes can cover all attribute categories corresponding to the each of the attributes. Independence between the attributes can avoid the annotating difficulty caused by ambiguous boundaries between the categories, thereby improve the annotating accuracy.

In some embodiments, the plurality of attributes for image annotating are determined according to feature information of an object to be annotated, and an image category is a category of the object to be annotated in the image to be annotated.

For example, the feature information is at least one of a physical feature or a facial feature of the object to be annotated. The physical feature can comprise body shape features, human body structure features, etc.; and the facial feature can comprise human tissue features such as hair, skin, five sense organs, face shape, etc.

For example, the attributes and tags corresponding to a classification task are determined by a computer using a preset model according to the requirements of the classification task.

In some embodiments, a plurality of basic attributes are extracted for the feature information to be annotated of the object in the image. These basic attributes of the feature information can cover the plurality of attributes related to this feature information.

For example, the object in the image is a person, and the feature information can be the plurality of attributes related to the person, such as hair, beard, hat, etc.

For example, for a hairstyle annotating task, the object in the image is a person, the feature information is a hairstyle, and the basic attributes can comprise hair length, hair curling degree, whether there are bangs, orientation of bangs, the number of braids, etc.

In some embodiments, the basic attributes of the feature information can comprehensively describe specific states of the feature information. For example, for the hairstyle annotating task, the basic attributes such as the hair length, the hair curling degree, whether there are bangs, the orientation of bangs, the number of braids, etc., can describe a specific hairstyle.

In some embodiments, the tags of the attribute can represent various states corresponding to the attribute. For example, tags corresponding to the hair length comprise long, short, medium; and the hair curling degree can comprise large, small, medium.

In some embodiments, tags corresponding to the orientation of bangs can comprise left, right, front, none. The tag “none” can guarantee that the orientation of bangs is independent of whether there are bangs.

The method of determining the attributes and the tags in the above embodiment has multiple advantages:

In the case where the number of annotating categories involved in the annotating task is relatively huge, different annotating categories can be characterized using combinations of a limited number of the basic attributes, thereby improving the annotating efficiency;

In the case where the annotating categories are difficult to be distinguished resulting from many small differences between them, distinction between the independent basic attributes is single (e.g., differences between different tags of the hair length only lying in the hair length and having nothing to do with the hair curling degree, etc.), thereby alleviating the annotating burden and improving the annotating efficiency.

In some embodiments, the tags corresponding to the image to be annotated are determined according to the feature information of the image to be annotated, to generate an image tag vector of the image to be annotated. For example, the tags can be determined by the computer using an image processing algorithm or a neural network.

For example, the image tag vector of the image to be annotated is generated using tags of two attributes: the hair length and the hair curling degree. According to the feature information of the person in the image, it can be determined that the hair length of the person in the image is long, the hair curling degree is large; and the image tag vector can be generated according to the two tags: long and large.

In some embodiments, according to tag similarity between the tags, the multiple tags corresponding to each of the attributes are sorted and a serial number corresponding to each tag is determined, and the closer the serial numbers of different tags are, the greater the tag similarity between the different tags; and the image tag vector and the category tag vector are generated according to the serial number corresponding to each tag.

In some embodiments, after the basic attributes of the annotating task are determined, the tags of these basic attributes can be sorted according to the tag similarity between the tags.

In some embodiments, for the attribute of the hair length, since similarity between long and medium is greater than that between long and short, the tags of the hair length can be sorted in the order from long to short: long corresponding to a serial number 1, medium corresponding to a serial number 2, short corresponding to a serial number 3.

Based on similar reasons, for the attribute of the hair curling degree, since similarity between large and medium is greater than that between large and small, the tags of the hair curling degree can be sorted in the order from large to small: large corresponding to a serial number 1, medium corresponding to a serial number 2, small corresponding to a serial number 3.

For example, the image tag vector of the image to be annotated is generated using the tags of the two attributes: the hair length and the hair curling degree. According to the feature information of the person in the image, it can be determined that the hair length of the person in the image is long, and the hair curling degree is large; and the image tag vector can be generated according to the two tags: long and large.

In this case, it can be determined that the image tag vector of the image is (1, 1).

In some embodiments, the tag similarity between the tags can be determined according to the classification requirements to sort the tags. For example, for the attribute of the orientation of bangs, it is determined that similarity between left and right is greater than that between left and front according to the classification requirements, and the tags of the orientation of bangs are sorted by: left corresponding to the serial number 1, right corresponding to the serial number 2, front corresponding to the serial number 3.

In step 120, the image category to which the image to be annotated belongs is annotated according to vector similarity between the image tag vector and the category tag vector of each of a plurality of image categories, and the category tag vector is generated according to the multiple tags corresponding to each of the attributes.

In some embodiments, after sample images are annotated with the basic attributes, each of the sample images has an image tag vector composed of the tags with the multiple basic attributes; and categories needing to be finally determined in the annotating task are also annotated with the basic attributes, which makes each of the categories also have a category tag vector composed of the tags of the multiple basic attributes.

For example, a matching database is generated using these category tag vectors; a vector distance (e.g., Euclidean distance, etc.) between image tag vector of each of the sample images and each of the category tag vectors in the matching database is calculated as vector similarity.

In some embodiments, the category tag vector is generated according to the serial numbers corresponding to the tags.

For example, the category tag vector is generated using the tags of the two attributes: the hair length and the hair curling degree. According to the classification requirements, it can be determined that: the hair length and the hair curling degree corresponding to a category A are respectively long and medium, and a category tag vector of the category A can be generated according to the two tags: long and medium; and the hair length and the hair curling degree corresponding to a category B are respectively short and small, and a category tag vector of the category B can be generated according to the two tags: short and small.

In this case, it can be determined that the category tag vector a of the category A is (1, 2), and that the category tag vector b of the category B is (3, 3); and the image tag vector of the image to be annotated is (1, 1), and the computer can determine through calculation that its distance to the category tag vector a is smaller than its distance to the category tag vector b, thereby determining that the image to be annotated belongs to the category A.

In some embodiments, it is detected whether an annotating result of the image to be annotated is correct according to image similarity between the image to be annotated and a reference image of the image category to which the image to be annotated belongs.

For example, it is detected whether the annotating result of the image to be annotated is correct according to image similarity between an object to be annotated in the image to be annotated and a reference object in the reference image of the image category to which the image to be annotated belongs.

For example, by using the computer to perform image processing such as edge detection and region segmentation on the image to be annotated and the reference image, image regions in which the object to be annotated is located in the two images can be determined; then, through the comparison of the image features (e.g., the comparison of sizes of the region in which the object is located, gray distributions the region in which the object is located, shape information the region in which the object is located, etc.), image similarity between the image regions is determined, thereby determining whether the annotating result is correct; or the image similarity of the two images can also be determined using the neural network.

For example, each of the image samples and a reference image of the most similar category in the matching database are spliced together; and it is detected whether the annotating result of the image to be annotated is correct according to whether the attributes of the two images spliced together are consistent.

FIG. 2 shows a flowchart of an image annotating method according to another embodiment of the present disclosure.

As shown in FIG. 2, in order to handle an annotating task with huge categories and certain ambiguity between the categories, the image annotating can be performed by the following steps.

In step 210, a plurality of basic attributes are extracted with respect to feature information to be annotated of an object in the image. These basic attributes of the feature information can cover a plurality of attributes related to this feature information.

For example, for a hairstyle annotating task, the object in the image is a person, the feature information is a hairstyle, the basic attributes can comprise hair length, hair curling degree, whether there are bangs, orientation of bangs, the number of braids, etc.

This method of determining the attributes and tags has multiple advantages:

In the case where the number of annotating categories involved in the annotating task is relatively huge, different annotating categories can be characterized using combinations of a limited number of these basic attributes, thereby improving the annotating efficiency;

In the case where the annotating categories are difficult to be distinguished resulting from many small differences between them, distinction between the independent basic attributes is single (e.g., differences between different tags of the hair length only lying in the hair length and having nothing to do with the hair curling degree, etc.), thereby alleviating the annotating burden and improving the annotating efficiency.

In step 220, after the basic attributes of the annotating task are determined, tags of these basic attributes can be sorted according to tag similarity between the tags.

In some embodiments, for the attribute of the hair length, since similarity between long and medium is greater than that between long and short, tags of the hair length can be sorted in the order from long to short: long corresponding a serial number 1, medium corresponding to a serial number 2, short corresponding to a serial number 3.

In step 230, after sample images are annotated with the basic attributes, each of the sample images has an image tag vector composed of the tags with the multiple basic attributes.

In step 240, categories needing to be finally determined in the annotating task are also annotated with the basic attributes, to makes each of the categories also have a category tag vector composed of the tags with the multiple basic attributes. For example, a matching database is generated using these category tag vectors.

In step 250, a vector distance (e.g., Euclidean distance, etc.) between image tag vector of each of the sample images and each of the category tag vectors in the matching database is calculated as vector similarity.

In step 260, each of the image samples and a reference image of the most similar category in the matching database are spliced together; and according to whether the attributes of the two images spliced together is consistent, it is detected whether an annotating result of image to be annotated is correct.

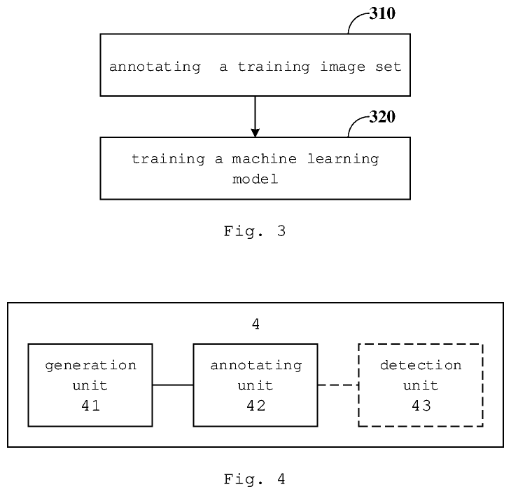

FIG. 3 shows a flowchart of a machine learning model training method according to some embodiments of the present disclosure.

As shown in FIG. 3, in step 310, an image in a training image set is annotated by the image annotating method according to any one of the above embodiments.

In step 320, a machine learning model for image classification is trained by using the training image set annotated.

In some embodiments, the image to be classified is processed using the machine learning model trained to determine an image category to which the image to be classified belongs.

FIG. 4 shows a block diagram of an image annotating apparatus according to some embodiments of the present disclosure.

As shown in FIG. 4, the image annotating apparatus 4 comprises a generation unit 41, an annotating unit 42.

The generation unit 41 generates an image tag vector of image to be annotated according to a plurality of attributes for image annotating and multiple tags corresponding to each of the attributes.

The annotating unit 42 tags an image category to which the image to be annotated belongs according to vector similarity between the image tag vector and a category tag vector of each of a plurality of image categories. The category tag vector is generated according to the multiple tags corresponding to each of the attributes.

In some embodiments, the annotating apparatus 4 further comprises: a detection unit 43 for detecting whether an annotating result of the image to be annotated is correct according to image similarity between the image to be annotated and a reference image of the image category to which the image to be annotated belongs.

For example, the detection unit 43 detects whether the annotating result of the image to be annotated is correct according to image similarity between an object to be annotated in the image to be annotated and a reference object in the reference image of the image category to which the image to be annotated belongs.

In some embodiments, the generation unit 41 sorts the plurality of tags corresponding to each of the attributes according to tag similarity between the tags, and determines a serial number corresponding to each tag; and generates an image tag vector and a category tag vector according to the serial number corresponding to each tag. The closer the tags being sorted, the greater the tag similarity between the tags.

In some embodiments, the generation unit 41 determines the tag corresponding to the image to be annotated according to feature information of the image to be annotated, to generate an image tag vector corresponding to the image to be annotated.

In some embodiments, the plurality of attributes for image annotating are independent of each other.

In some embodiments, the multiple tags corresponding to each of the attributes can cover all attribute categories corresponding to the each of the attributes.

In some embodiments, the plurality of attributes for image annotating are determined according to feature information of an object to be annotated, and the image category is a category of an object to be annotated in the image to be annotated. For example, the feature information is at least one of a physical feature or facial feature of the object to be annotated.

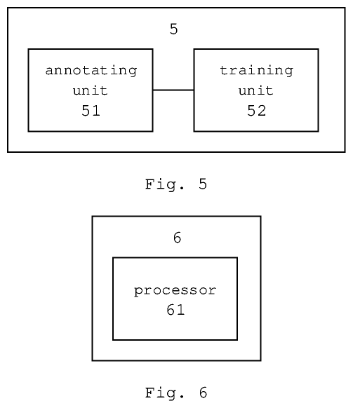

FIG. 5 shows a block diagram of a machine learning model training apparatus according to some embodiments of the present disclosure.

As shown in FIG. 5, the machine learning model training apparatus 5 comprises: an annotating unit 51 for annotating images in a training image set by the image annotating method according to any one of the above embodiments; a training unit 52 for training a machine learning model for image classification using the training image set annotated.

FIG. 6 shows a block diagram of an image classification apparatus according to some embodiments of the present disclosure.

As shown in FIG. 6, the image classification apparatus 6 comprises: a processor 61 for processing an image to be classified using a machine learning model to determine an image category to which the image to be classified belongs. The machine learning model is trained using the machine learning model training method according to any one of the above embodiments.

It should be noted that the above units are only logic modules divided according to specific functions they realize, rather than limiting specific implementations, and can be implemented in, for example, software, hardware, or a combination of software and hardware. In an actual implementation, the above units can be implemented as separate physical entities, or can be implemented by a single entity (e.g., a processor (CPU or DSP, etc.), an integrated circuit, and the like). In addition, the above units are shown with dotted lines in the drawings, which indicates that these units may not actually exist and the operations/functions realized by them can be implemented by the processing circuit itself.

Moreover, although not shown, the apparatus can also comprise a memory, on which can be stored various information generated in operations by the apparatus and each unit contained in the apparatus, procedures and data for the operations, data to be transmitted by a communication unit, etc. The memory can be a volatile memory and/or a non-volatile memory. For example, the memory can comprise, but is not limited to, a random access memory (RAM), a dynamic random access memory (DRAM), a static random access memory (SRAM), a read-only memory (ROM), a flash memory. Of course, the memory can also be outside the apparatus. Alternatively, although not shown, the apparatus can also comprise the communication unit for communicating with another apparatus. In one example, the communication unit can be implemented in an appropriate manner known in the art, and comprises, for example, communication components such as an antenna array and/or radio frequency link, various types of interfaces and communication units, etc., which will not be described in detail herein. Furthermore, the apparatus can also comprise other components not shown, such as a radio frequency link, baseband processing unit, network interface, processor, controller, etc., which will not be described in detail herein.

According to some embodiments of the present disclosure, an electronic device is also provided.

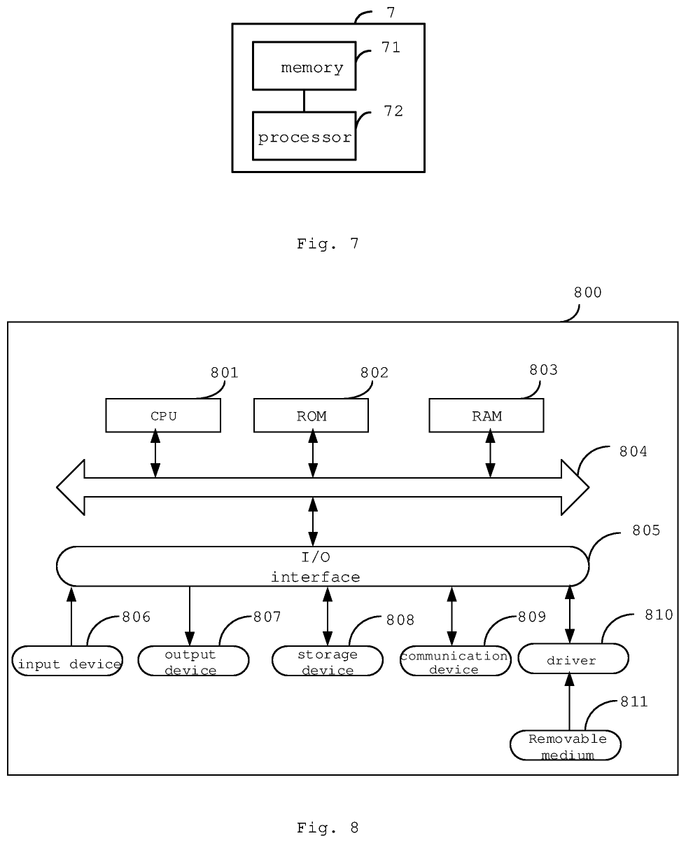

FIG. 7 shows a block diagram of an electronic device according to some embodiments of the present disclosure.

For example, in some embodiments, an electronic device 7 can be various types of devices, which can comprise, but are not limited to, for example, mobile terminals such as a mobile phone, laptop computer, digital broadcast receiver, PDA (personal digital assistant), PAD (tablet), PMP (portable multimedia player), on-vehicle terminal (e.g., on-vehicle navigation terminal), etc., fixed terminals such as a digital TV, desktop computer, etc. For example, the electronic device 7 can comprise a display panel for displaying the data and/or execution result used in the solutions of the present disclosure. For example, the display panel can be various shapes, such as a rectangular panel, an elliptical panel, a polygon panel, or the like. In addition, the display panel can be not only a planar panel, but also a curved panel, or even a spherical panel.

As shown in FIG. 7, the electronic device 7 of this embodiment comprises: a memory 71 and a processor 72 coupled to the memory 71. It should be noted that the components of the electronic device 7 shown in FIG. 7 are merely exemplary, rather than restrictive, and the electronic device 7 can also have other components according to the actual application requirements. The processor 72 can control the other components in the electronic device 7 to perform desired functions.

In some embodiments, the memory 71 is configured to store one or more computer-readable instructions. When the processor 72 is configured to operate the computer-readable instructions, the computer-readable instructions implement the method according to any one of the above embodiments when operated by the processor 72. The specific implementation of the steps of the method and its relevant explanation can refer to the above embodiments, and are not repeated herein.

For example, the processor 72 and the memory 71 can communicate with each other directly or indirectly. For example, the processor 72 and the memory 71 can communicate over a network. The network can comprise a wireless network, a wired network, and/or any combination of the wireless network and wired network. The processor 72 and the memory 71 can also communicate with each other through a system bus, which is not limited by the present disclosure.

For example, the processor 72 can be embodied as various suitable processors, processing devices, etc., such as a central processing unit (CPU), a graphics processing unit (GPU), a network processor (NP), etc.; and can also be a digital signal processor (DSP), an application specific integrated circuit (ASIC), a field programmable gate array (FPGA) or another programmable logic device, a discrete gate or transistor logic device, a discrete hardware component. The central processing unit (CPU) can be an X86 or ARM architecture, etc. For example, the memory 71 can comprise any combination of various forms of computer-readable storage media, such as a volatile memory and/or non-volatile memory. The memory 71 can comprise, for example, a system memory which has thereon stored, for example, an operating system, application, boot loader, database, another program and the like. Various applications and various data can also be stored in the storage medium.

In addition, according to some embodiments of the present disclosure, in the case where various operations/processes according to the present disclosure are implemented by software and/or firmware, a program constituting the software can be installed from a storage medium or network to a computer system with a dedicated hardware structure, e.g., the computer system of the electronic device 800 shown in FIG. 8. When various programs are installed in the computer system, the computer system is capable of performing various functions comprising the functions such as those described above.

FIG. 8 shows a block diagram of an electronic device according to other embodiments of the present disclosure.

In FIG. 8, a central processing unit (CPU) 801 performs various processing according to a program stored in a read-only memory (ROM) 802 or a program loaded from a storage section 808 to a random access memory (RAM) 803. The data required when the CPU 801 performs various processing or the like are also stored in the RAM 803 as needed. The central processing unit is merely exemplary, which can also be other types of processors, such as various processors described above. The ROM 802, RAM 803 and storage section 808 can be various forms of computer-readable storage media, as described below. It should be noted that although the ROM 802, RAM 803, and storage device 808 are respectively shown in FIG. 8, one or more of them can be merged in or located in a same memory or storage module, or in different memories or storage modules.

The CPU 801, ROM 802 and RAM 803 are connected to each other via a bus 804. An input/output interface 805 is also connected to the bus 804.

The following components are connected to the input/output interface 805: an input section 806, such as a touch screen, touch panel, keyboard, mouse, image sensor, microphone, accelerometer, gyroscope, etc.; an output section 807, comprising a display, such as a cathode ray tube (CRT)), liquid crystal display (LCD), speaker, vibrator, etc.; a storage section 808, comprising a hard disk, tape, etc.; and a communication section 809, comprising a network interface card, such as a LAN card, modem, and the like. The communication section 809 allows for communication processing via a network such as the Internet. It is readily understood that although each device or module in the electronic device 800 shown in FIG. 8 communicates through the bus 804, they can also communicate over a network or by other means, wherein the network can comprise a wireless network, a wired network, and/or any combination of the wireless network and the wired network.

A driver 810 is also connected to the input/output interface 805 as needed. A removable medium 811 such as a magnetic disk, an optical disk, a magneto-optical disk, a semiconductor memory, and the like is installed on the driver 810 as needed, so that a computer program read out of it is installed into the storage section 808 as needed.

In the case where the above series of processing is implemented by software, a program constituting the software can be installed from a network such as an Internet or a storage medium such as the removable medium 811.

According to an embodiment of the present disclosure, the process described above with reference to the flowchart can be implemented as a computer software program. For example, an embodiment of the present disclosure comprises a computer program product comprising a computer program carried on a computer-readable medium, and the computer program contains program code for performing the method shown in the flowchart. In such an embodiment, the computer program can be downloaded and installed from the network through the communication device 809, or is installed from the storage device 808, or is installed from the ROM 802. When the computer program is executed by the CPU 801, the above functions defined in the method of the embodiment of the present disclosure are performed.

It should be noted that in the context of the present disclosure, the computer-readable medium can be a tangible medium, which can have thereon contained or stored a program for use by or in combination with an instruction execution system, apparatus, or device. The computer-readable medium can be a computer-readable signal medium or a computer-readable storage medium or any combination of the above. The computer-readable storage medium can be, for example, but is not limited to, an electrical, magnetic, light, electromagnetic, infrared, or semiconductor system, apparatus or device, or any combination of the above. A more specific example of the computer-readable storage medium can comprise, but is not limited to, an electrical connection having one or more wires, portable computer disk, hard disk, random access memory (RAM), read-only memory (ROM), erasable programmable read-only memory (EPROM or flash), fiber, portable compact disk read-only memory (CD-ROM), optical storage device, magnetic storage device, or any suitable combination of the above. In the present disclosure, the computer-readable storage medium can be any tangible medium having thereon contained or stored programs for use by or in combination with an instruction execution system, apparatus, or device. And in the present disclosure, the computer-readable signal medium can comprise a data signal propagating in baseband or as part of a carrier, in which the computer-readable program code is carried. This propagating data signal can take a plurality of forms, comprising but not limited to an electromagnetic signal, an optical signal, or any suitable combination of the above. The computer-readable signal medium can also be any computer-readable medium except the computer-readable storage medium, which can send, propagate, or transmit a program for use by or in combination with an instruction execution system, apparatus, or device. The program code contained on the computer-readable medium can be transmitted with any suitable medium, comprising but not limited to, a wire, optical cable, RF, etc., or any suitable combination of the above.

The above computer-readable medium can be contained in the above electronic device; and can also exist alone, instead of being assembled into the electronic device.

In some embodiments, a computer program is also provided, comprising: instructions which, when executed by a processor, cause the processor to execute the method according to any one of the above embodiments. For example, the instructions can be embodied as computer program code.

In an embodiment of the present disclosure, computer program code for performing the operations of the present disclosure can be written in one or more programming languages or a combination thereof, and the above programming language comprises, but is not limited to, object-oriented programming languages such as Java, SmallTalk, C++, and also comprises conventional procedural programming languages, such as “C” language or similar programming languages. The program code can be executed completely on a user's computer, partially on a user's computer, as a separate software package, partially on a user's computer and partially on a remote computer, or completely on a remote computer or server. In the case where a remote computer is involved, the remote computer can be connected to the user's computer through any type of network (comprising a local area network (LAN) or a wide area network (WAN)), or can be connected to an external computer (e.g., connected through the Internet using the Internet service provider).

The flowcharts and block diagrams in the drawings illustrate the practicable architecture, functions, and operations of the system, methods, and computer program products according to various embodiments of the present disclosure. In this regard, each block in the flowcharts or block diagrams can represent a portion of a module, program segment, or code, which contains one or more executable instructions for implementing a specified logical function. It should also be noted that in some alternative implementations, functions stated in the blocks can also occur in the order different from the order stated in the drawings. For example, two consecutive blocks can actually be performed substantially in parallel, and they can sometimes be performed in reverse order, which depends on the functions involved. It should also be noted that each block in the block diagrams and/or the flowcharts, and a combination of blocks in the block diagrams and/or the flowcharts, can be implemented by a dedicated hardware-based system performing specified functions or operations, or by a combination of dedicated hardware and computer instructions.

The modules, components, or units involved in the description of the embodiments of the present disclosure can be implemented by software, or by hardware. Therein, a name of the module, component, or unit does not constitute a limitation on the module, component, or unit itself in some case.

The functions described above herein can be performed at least partially by one or more hardware logic components. For example, an available hardware logic component, which is exemplary instead of restrictive, comprises: a field programmable gate array (FPGA), application specific integrated circuit (ASIC), application specific standard product (ASSP), system on chip (SOC), complex programmable logic device (CPLD), etc.

The above description is only some embodiments of the present disclosure and an explanation of the applied technical principles. Those skilled in the art will appreciate that the disclosure scope involved in this disclosure is not limited to the technical solutions formed by a specific combination of the above technical features, but also covers other technical solutions formed by an arbitrary combination of the above technical features or their equivalent features without departing from the above disclosure concept. For example, a technical solution is formed by performing mutual replacement on the above technical features and the technical features with similar functions disclosed (but not limited to) in the present disclosure.

In the description provided herein, many specific details are elaborated. However, it is understood that the embodiments of the present invention can be implemented without these specific details. In other cases, well-known methods, structures, and techniques are not shown in detail in order not to obscure the understanding of the description.

In addition, although the operations are described in a specific order, this should not be understood as requiring these operations to be performed in the specific order shown or performed in a sequential order. Under certain circumstances, multitasking and parallel processing may be advantageous. Similarly, although several specific implementation details are comprised in the above discussion, they should not be construed as limiting the scope of the present disclosure. Certain features that are described in the context of individual embodiments can also be implemented in combination in a single embodiment. Conversely, various features described in the context of the single embodiment can also be implemented in multiple embodiments individually or in any suitable sub-combination.

Although some specific embodiments of the present disclosure have been described in detail by way of examples, those skilled in the art will appreciate that the above examples are for illustration only and are not intended to limit the scope of the present disclosure. Those skilled in the art will appreciate that the above embodiments can be modified without departing from the scope and spirit of the present disclosure. The scope of the present disclosure is defined by the claims attached therein.

What is claimed is:

1. An image annotating method, comprising:
generating an image tag vector of an image to be annotated, according to a plurality of attributes for image annotating and multiple tags corresponding to each of the attributes; and
annotating an image category to which the image to be annotated belongs, according to vector similarity between the image tag vector and a category tag vector of each of a plurality of image categories, wherein the category tag vector is generated according to the multiple tags corresponding to each of the attributes.

2. The image annotating method according to claim 1, further comprising:
sorting the multiple tags corresponding to each of the attributes and determining a serial number corresponding to each tag, according to tag similarity between tags, wherein the closer the serial numbers of different tags are, the greater the tag similarity between the different tags, the image tag vector and the category tag vector are generated according to the serial number corresponding to each tag.

3. The image annotating method according to claim 1, wherein the generating an image tag vector of an image to be annotated, according to a plurality of attributes for image annotating and multiple tags corresponding to each of the attributes comprises:
determining one or more tags corresponding to the image to be annotated, according to feature information of the image to be annotated, to generate the image tag vector corresponding to the image to be annotated.

4. The image annotating method according to claim 1, wherein the plurality of attributes for image annotating are independent of each other.

5. The image annotating method according to claim 1, wherein the multiple tags corresponding to an attribute cover all attribute categories corresponding to the attribute.

6. The image annotating method according to claim 1, wherein the plurality of attributes for image annotating are determined according to feature information of an object to be annotated, the image category is a category of an object to be annotated in the image to be annotated.

7. The image annotating method according to claim 6, wherein, the feature information is at least one of a physical feature or a facial feature of the object to be annotated.

8. The image annotating method according to claim 1, further comprising:
detecting whether an annotating result of the image to be annotated is correct, according to an image similarity between the image to be annotated and a reference image of the image category to which the image to be annotated belongs.

9. The image annotating method according to claim 8, wherein the detecting whether an annotating result of the image to be annotated is correct, according to an image similarity between the image to be annotated and a reference image of the image category to which the image to be annotated belongs comprises:
detecting whether the annotating result of the image to be annotated is correct, according to a similarity between an object to be annotated in the image to be annotated and a reference object in the reference image of the image category to which the image to be annotated belongs.

10. A machine learning model training method, comprising:
annotating images in a training image set, by the image annotating method according to claim 1; and
training a machine learning model for image classification using the training image set annotated.

11. An image classification method, comprising:
processing an image to be classified using a machine learning model to determine an image category to which the image to be classified belongs, wherein the machine learning model is trained using the machine learning model training method according to claim 10.

12. An image classification apparatus, comprising:
a processor configured to process an image to be classified using a machine learning model to determine an image category to which the image to be classified belongs, wherein the machine learning model is trained using the machine learning model training method according to claim 10.

13. An electronic device, comprising:
a memory; and
a processor coupled to the memory, the processor configured to, based on instructions stored in the memory, implement the image annotating method according to claim 1.

14. An electronic device, comprising:
a memory; and
a processor coupled to the memory, the processor configured to, based on instructions stored in the memory, implement the machine learning model training method according to claim 10.

15. An electronic device, comprising:
a memory; and
a processor coupled to the memory, the processor configured to, based on instructions stored in the memory, implement the image classification method according to claim 11.

16. A non-transitory computer-readable storage medium on which a computer program is stored, which when executed by a processor, implements the image annotating method according to claim 1.

17. A non-transitory computer-readable storage medium on which a computer program is stored, which when executed by a processor, implements the machine learning model training method according to claim 10.

18. A non-transitory computer-readable storage medium on which a computer program is stored, which when executed by a processor, implements the image classification method according to claim 11.
